(19) United States
(12) Patent Application Publication
(10) Pub. No.: US 2025/0305837 A1
(43) Pub. Date: Oct. 2, 2025

(54) AI ACCESSORY DEVICE, OPERATING SYSTEM AND CONTROL METHOD THEREOF

(71) Applicant: VIA LABS, INC., New Taipei City (TW)

(72) Inventors: Chin-Sung HSU, New Taipei City (TW); Nai-Chuan HUNG, New Taipei City (TW)

(21) Appl. No.: 19/086,278

(22) Filed: Mar. 21, 2025

Related U.S. Application Data
(60) Provisional application No. 63/570,316, filed on Mar. 27, 2024.

(30) Foreign Application Priority Data
Jan. 24, 2025 (TW) 114103571

(51) Int. Cl. G01C 21/32; G01C 21/36

(52) U.S. Cl. CPC G01C 21/32; G01C 21/3611; G01C 21/3629

(57) ABSTRACT

An artificial intelligence (AI) accessory device coupled to an electronic device is provided. The AI accessory device includes an input interface, a vendor-defined category circuit, a standard category circuit, and a transmission interface. The input interface receives multimodal input. The vendor-defined category circuit provides a first multimodal data signal to the electronic device for processing by an AI module. The standard category circuit receives processed multimodal data from the vendor-defined category circuit and provides a second multimodal data signal to an application on the electronic device. The transmission interface facilitates communication between the AI accessory device and the electronic device.

### CROSS REFERENCE TO RELATED APPLICATIONS

This application claims priority to U.S. Provisional Application No. 63/570,316, filed Mar. 27, 2024, and Taiwan (R.O.C.) patent application No. 114103571, filed Jan. 24, 2025, the entirety of which is incorporated by reference herein.

### BACKGROUND OF THE INVENTION

### Field of the Invention

The present disclosure relates to an artificial intelligence (AI) accessory device, and in particular, to an artificial intelligence accessory device having both vendor-defined categories and standard categories.

### Description of the Related Art

Traditionally, applying multimedia, such as images, video, text, speech, music, games, or 3D, as multi-modality data in artificial intelligence (AI) processing often faces various limitations. For example, the signal processing capabilities of AI accessory devices are limited. Many AI accessory devices rely on built-in digital signal processors (DSPs) to process incoming multimodal data. However, DSPs are expensive, leading to high prices for AI accessory devices, which limits their widespread adoption.

Furthermore, native applications (APPs) on mobile devices often lack sufficient AI capabilities. The native APPs of mobile devices often lack advanced AI processing capabilities. Users who wish to experience AI functionality usually need to purchase higher-end mobile devices or install new APPs, causing inconvenience.

Additionally, traditional AI processing methods lack flexibility in multi-modal data processing. Conventional AI processing methods are usually limited to single-modality conversion, such as converting speech to text, which lacks the ability to integrate and process across multiple modalities. This makes it difficult to cope with increasingly diverse AI application scenarios.

Therefore, there is a need for a more efficient or more flexible artificial intelligence accessory device and operating system to overcome the above limitations.

### BRIEF SUMMARY OF THE INVENTION

An embodiment of the present disclosure provides an artificial intelligence (AI) accessory device for coupling to an electronic device, comprising: an input interface configured to receive a multimodal input and to transmit corresponding multimodal data; a vendor-defined category circuit coupled to the input interface and configured to provide a first multimodal data signal in a vendor-defined category format to the electronic device according to the multimodal data received from the input interface, wherein the first multimodal data signal is configured to be processed by an AI module of the electronic device to generate processed multimodal data for the vendor-defined category circuit; a standard category circuit configured to receive the processed multimodal data from the vendor-defined category circuit and to provide the processed multimodal data as a second multimodal data signal to an application of the electronic device; and a transmission interface coupled to the electronic device to transmit and receive the first multimodal data signal, the second multimodal data signal, and the processed multimodal data.

Another embodiment of the present disclosure provides an operating system including the AI accessory device and an electronic device The electronic device comprises: an AI module, wherein the AI module is a generative AI installed in the electronic device or located in a cloud, and wherein the generative AI is a generative adversarial network, a long short-term memory network, or a Transformer model; and an application installed in the electronic device and configured to receive the second multimodal data signal.

A further embodiment of the present disclosure provides a control method for an artificial intelligence (AI) operating system, comprising an electronic device and the AI accessory device; wherein the electronic device comprises: an AI module, wherein the AI module is a generative AI installed in the electronic device or located in a cloud, and wherein the generative AI is a generative adversarial network, a long short-term memory network, or a Transformer model; and an application installed in the electronic device and configured to receive a multimodal data signal; the control method further comprises: a data acquisition and format conversion step, wherein the AI accessory device receives the multimodal data through the input interface and transmits the multimodal data to the vendor-defined category circuit, and the vendor-defined category circuit packages the multimodal data into a first multimodal data signal in a vendor-defined category format; a data transmission and AI processing step, transmitting the first multimodal data signal to the electronic device, wherein the AI module of the electronic device performs a conversion process; a multimodal conversion step, wherein the conversion process converts the received first multimodal data signal into processed multimodal data; a return and format conversion step, transmitting the processed multimodal data, which is still in the vendor-defined category format, to the AI accessory device, and transmitting the processed multimodal data to the standard category circuit, which converts the processed multimodal data from the vendor-defined category format into a second multimodal data signal in a standard category format; and a standard format data return step, wherein the AI accessory device transmits the second multimodal data signal in the standard category format to the electronic device for execution and processing by the application.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of a system including an artificial intelligence (AI) accessory device and an electronic device, according to an embodiment of the present disclosure.

FIG. 2 is a schematic diagram of a possible embodiment of the AI accessory device of the present disclosure.

FIG. 3 is a schematic diagram of another possible embodiment of the AI accessory device of the present disclosure.

FIG. 4 is a schematic diagram of another possible embodiment of the AI accessory device of the present disclosure.

FIG. 5 is a schematic diagram of another possible embodiment of the AI accessory device of the present disclosure.

FIG. 6 is a schematic block diagram of the AI accessory device of the present disclosure.

FIG. 7 is a schematic diagram of a system including the AI accessory device and an electronic device, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

The present disclosure provides an artificial intelligence (AI) accessory device. In some embodiments, the AI accessory device can couple to an electronic device. In some embodiments, the AI accessory device captures images/video/text/speech/music/games/3D as multi-modality data, but is not limited thereto. The present disclosure is not limited to one-to-one conversion.

The present disclosure can convert images/video/text/speech/music/games/3D into various combinations of images/video/text/speech/music/games/3D. The above combinations are referred to as multi-modality. This combination function will be able to be flexibly adapted to various scenarios and extended to various AI-related applications in the future.

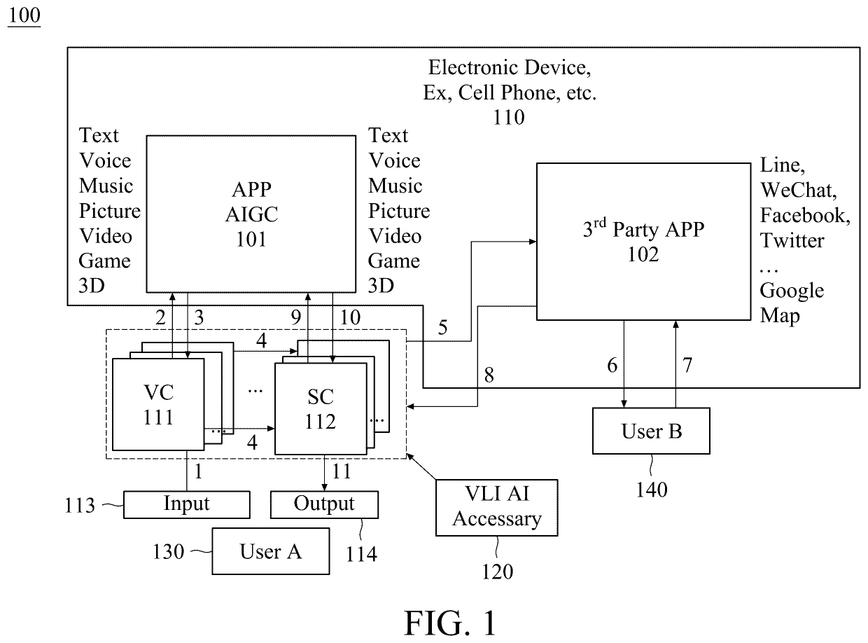

FIG. 1 is a schematic diagram of a system 100 including an artificial intelligence (AI) accessory device and an electronic device according to an embodiment of the present disclosure.

As shown in FIG. 1, the present disclosure provides an artificial intelligence (AI) accessory device 120 for capturing multimodal data, including but not limited to images, video, text, speech, music, games, or 3D data.

The images/video/text/speech/music/games/3D will first be input by an input interface 113, transmitted to the AI accessory device 120 through a path 1, and packaged into a vendor-defined class format by a vendor-defined class (VC) circuit 111, and then transmitted to an electronic device 110 through a path 2.

In an embodiment, an AI module 101, which is additionally installed in the electronic device 110, is an application program or a built-in/cloud-based generative AI model. In an embodiment, a transformer process is performed by the AI module 101 to convert the received multimodal combination (images/video/text/speech/music/games/3D) into another multimodal combination (images/video/text/speech/music/games/3D), and then transmit the another multimodal combination back to the AI accessory device through a path 3. In an embodiment, speech can be converted into a multimodal combination of text and speech, images can be converted into a multimodal combination of text and video, etc.

In an embodiment, the returned data format is still the vendor-defined class format. The vendor-defined class format data is transmitted to a standard class (SC) circuit 112 through an internal path 4 of the AI accessory device. The standard class circuit converts the vendor-defined class format data into standard class format data.

In an embodiment, application program 102 is an application program installed on the electronic device and is capable of receiving and processing input of standard class format data. It may be a native application program (such as web browser software) installed at the factory of the electronic device, or a third-party program (such as LINE APP) arbitrarily installed by a user.

In an embodiment, the AI accessory device transmits the standard class format data back to the electronic device through a path 5 for execution and processing by the application program 102. The application program 102 treats it as normal input, receives it, and processes it.

In an embodiment, the data in the standard class format may be returned to the AI module installed on the electronic device, but not limited thereto. In an embodiment, a second conversion may be performed, for example, translating English into Chinese, or may be converted into a multimodal data combination (for example, converting images into speech and text, but not limited thereto), and sent to the application program 102 of the electronic device 110 for output, or sent to an output interface 114 of the AI accessory device 120 for output.

In an embodiment, the result of the second conversion described above may be sent to various application programs 102 of the electronic device for processing. When a first user 130 of the electronic device 110 opens different electronic device application programs 102, the result of the first conversion and the result of the second conversion may be processed and utilized by different electronic device application programs 102.

In an embodiment, the AI accessory device 120 corresponding to the multimodal mode includes at least one vendor-defined category circuit 111 and at least one standard category circuit 112. For example, when converting an input image into speech and text, a first vendor-defined category circuit is needed to convert the input image into image vendor-defined category data. In an embodiment, a second vendor-defined category circuit is needed to receive the converted speech vendor-defined category data. A third vendor-defined category circuit is needed to receive the converted text vendor-defined category data.

In an embodiment, through the internal path 4, the converted speech vendor-defined category data and text vendor-defined category data are respectively transmitted to the corresponding standard category circuits, and then transmitted to the application program 102, and/or output to a speaker on the electronic device, or headphones or speakers connected to the output interface 114 of the AI accessory device 120 (paths 9, 10, and the output interface 114), but not limited thereto. In short, as long as the input is at least one of multimodal (images/video/text/speech/music/games/3D . . . ), the AI accessory device 120 can package the input multimodal data into a vendor-defined category format by the vendor-defined category circuit 111.

In an embodiment, the input interface 113 and the output interface 114 of the AI accessory device 120 of the present disclosure may be in various forms. They may also be integrated into a bidirectional transmission interface, for example, a Universal Serial Bus (USB) interface, and data transmission may be wired/wireless transmission, such as Bluetooth, WIFI, etc. In an embodiment, the interfaces of each path 1-10 may be the same or combined in different ways.

In an embodiment, the input interface 113 and the output interface 114 may be included in the AI accessory device 120 or outside the AI accessory device 120. The pre-processing and post-processing of the input interface 113 and the output interface 114 may include an analog-to-digital conversion (A/D) module and a digital-to-analog conversion (D/A) module for converting analog signals into digital signals and converting digital signals into analog signals.

In an embodiment, the input interface 113 is used to capture data such as images/video/text/speech/music/games/3D, and therefore may be equipped with image capture devices, such as video cameras, cameras, etc. The input interface 113 may also include sound capture devices, such as microphones, etc.

In an embodiment, the output interface 114 may be a speaker/headphone, etc., but not limited thereto. In addition, the output interface 114 may also output control signals for controlling external devices to generate vibration, providing feedback to the receiving end, etc.

In an embodiment, the input interface 113 and the output interface 114 may be replaced by other input interfaces and output interfaces built-in or externally connected to the electronic device 110. For example, if the electronic device 110 is a smart phone, the input interface 113 may be replaced by the microphone of the smart phone, and the output interface 114 may be replaced by the speaker of the smart phone. In this case, data is received and transmitted via the transmission interface connected to the electronic device 110.

In an embodiment, the AI accessory device 120 may also be equipped with a 3.5 mm headphone jack. When headphones are not plugged in, audio is played by the speaker of the electronic device 110 or the AI accessory device 120; when headphones are plugged in, audio is played by the headphones.

In an embodiment, the AI accessory device 120 may have a built-in microcomputer unit (MCU) for managing data transmission and reception between internal circuit modules such as the VC circuit 111, the SC circuit 112, the input interface 113, and the output interface 114.

In an embodiment, the electronic device 110 may be a mobile device, and the application program 102 may be a native/built-in APP of the mobile device. For the native/built-in APP of the mobile device, the present disclosure converts the AI-processed data into a standard class (SC) format, which is a standard format that can be directly received and processed by the native/built-in APP. Therefore, users of the mobile device do not need to upgrade the native/built-in APP to experience the AI processing effect. That is, it can be used without upgrading or updating the APP or the mobile device. In addition, the AI accessory device of the present disclosure is also very convenient and intuitive to use with a mobile device.

In an embodiment, the AI accessory device 120 may also be equipped with a hub circuit. The at least one VC circuit 111 and the at least one SC circuit 112 may be located within the HUB circuit, or may be independent of the HUB circuit. In an embodiment, the HUB circuit is used to expand the ports of the mobile device, for example, it can increase the number of USB ports, etc., and can also be used to provide functions such as charging, listening to music, transmitting data, etc., but not limited thereto.

The following uses a first embodiment to illustrate how to use a communication APP on a mobile device to achieve AI real-time translation of text and speech during a call.

In the first embodiment, the electronic device 110 may be a mobile device, the application program 102 may be a communication APP of the mobile device (such as LINE), the user 130 is the caller who uses the communication APP to make a call, and the user 140 is the receiver who talks to the caller, but not limited thereto.

In the first embodiment, the caller uses LINE to make a call with the receiver, and uses the Chinese-English speech translation function (corresponding paths are 1, 2, 3, 4), and the receiver will hear the translated English speech (corresponding paths are 5, 6).

In the first embodiment, the receiver replies in English speech, and the caller's mobile device screen will display the translated Chinese text (corresponding paths are 7, 8, 9) and/or play the translated Chinese speech through the speaker (corresponding paths are 10, output interface).

In the first embodiment, the detailed steps are as follows:

Speech signal capture and format conversion step: as shown in FIG. 1, when the caller uses LINE to talk with the receiver, the system will simultaneously perform speech translation (paths 1, 2, 3, 4). The Chinese speech signal spoken by the caller will be transmitted to the VC circuit 111 of speech through the input device (such as a microphone) connected to the input interface 113 and path 1. The speech VC circuit 111 packages the Chinese speech signal into a Chinese speech vendor-defined class format and transmits it to the AI module 101 through path 2.

In an embodiment, the AI module 101 may be a software APP installed on the mobile device, or a built-in or cloud-based generative AI, such as Generative Adversarial Networks (GAN), Long Short-Term Memory (LSTM), or Transformer models (such as ChatGPT), capable of providing AI Generated Content (AIGC), but not limited thereto, hereinafter also referred to as APP AIGC.

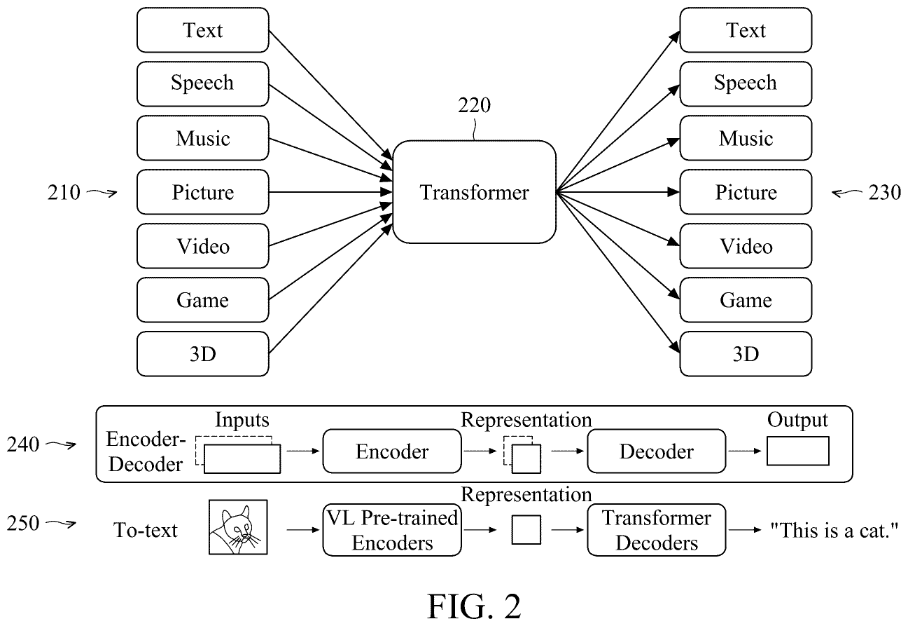

FIG. 2 is a possible embodiment of the AI accessory device of the present disclosure. As shown in FIG. 2, the multimodal input 210 includes any one of text, speech, music, images, video, games, and 3D models, and is converted into a multimodal output 230 including any one of text, speech, music, images, video, games, and 3D models through a conversion model 220 included in the APP AIGC, and is output as processed multimodal data.

In an embodiment, as shown in FIG. 2, the conversion model 220 of the APP AIGC can be regarded as a codec process 240. After the multimodal input 210 enters the encoder, it goes through a conversion representation process and is output by the decoder to obtain another multimodal output, but not limited thereto.

In an embodiment, as shown in FIG. 2, the conversion model 220 of the APP AIGC can be regarded as a text conversion process 250. In this example, the multimodal input 210 is a picture of a cat. After entering the trained encoder, it goes through a conversion representation process, and a text output “This is a cat” is obtained through the conversion decoder, but not limited thereto.

In an embodiment, the following multimodal conversion steps may be included. The APP AIGC will convert the Chinese speech vendor-defined class format signal into processed multimodal data, and this processed multimodal data still has a vendor-defined class format signal, for example, the processed multimodal data has an English speech vendor-defined class format signal and an English text vendor-defined class format signal.

In an embodiment, the following return and format conversion steps may be included. The converted English speech vendor-defined class format signal and English text vendor-defined class format signal are returned to the corresponding vendor-defined class circuit 111 in the AI accessory device through path 3. Then, the converted English speech vendor-defined class format signal and English text vendor-defined class format signal are transmitted to the corresponding speech SC circuit 112 and text SC circuit 112 through path 4, respectively, and converted into an English speech SC format signal and an English text SC format signal. In an embodiment, the path 4 is a physical hard-wired connection between hardware circuits, but not limited thereto.

In an embodiment, the following standard format data return and output steps may be included. The converted English speech SC format signal and English text SC format signal will be used as the second multimodal data signal and returned to the application program 102 (such as LINE APP, but not limited thereto) on the electronic device 110 through path 5. The second user 140 (receiver) will hear the translated English speech through path 6. At the same time, the second user can also see the corresponding English text on the application program (LINE APP) on his electronic device.

In an embodiment, when the second user 140 replies in English speech, the application program 102 will receive the speech signal through path 7. At this time, the received English speech signal is an English speech SC format signal. The signal will be transmitted to the corresponding SC circuit 112 through path 8, and then transmitted to the AI module 101 through path 9 for a second conversion, for example, converting the English speech SC format signal into a Chinese speech SC format signal and a Chinese text SC format signal.

The converted Chinese speech SC format signal and Chinese text SC format signal will be returned to the corresponding SC circuit 112 in the AI accessory device 120 through path 10. The application program 102 of the mobile device can reuse these Chinese speech SC format signals and Chinese text SC format signals.

In this way, the first user 130 can see the Chinese text translated from the English speech SC format signal in real time on the mobile device screen, or/and hear the Chinese speech translated from the English speech SC format signal in real time, which can be played through the speaker on the mobile device or the output interface 114 (such as headphones) of the AI accessory device 120 (path 11, output interface).

All of the above applications are plug-and-play, which is not only convenient for users, but also convenient for second users. For example, in the above call example, the second user 140 does not need to install any software or establish an additional APP, and can use the ordinary LINE or FB call function to receive the translated voice. When the second user 140 replies in their own language, the first user 130 will hear the translated voice.

Through the above description and steps, the present disclosure demonstrates how to achieve convenient and real-time AI two-way voice and text translation functions in communication APPs, effectively reducing the threshold for cross-language communication and improving user experience.

The following uses a second embodiment to illustrate how to use the present disclosure to implement AI navigation and AI navigation warning functions.

As shown in FIG. 1, suppose the first user 130 (e.g., a visually impaired person) uses an image capture device (e.g., an AI brooch) to convert street view images into speech (transmitted to a speaker/headphone) to warn the visually impaired person of dangers ahead (paths 1, 2, 3, 4, 9, 10, output interface). The detailed steps in the second embodiment are as follows.

In an embodiment, street view image capture and format conversion steps may be included. The street view image signal will be transmitted to the image vendor-defined category (VC) circuit 111 through the input device (such as a camera) coupled to the input interface 113 and path 1. The image VC circuit 111 encapsulates the street view image signal into an image VC format and transmits it to the electronic device 110 (mobile device) through path 2, where it is processed by the AI module 101. In an embodiment, the AI module 101 may be a software APP installed on the mobile device, a built-in or cloud-based generative AI, but not limited thereto, hereinafter also referred to as APP AIGC.

In an embodiment, a multimodal conversion step may be included. As shown in FIG. 2, the APP AIGC will convert the received first multimodal data signal into processed multimodal data, for example, converting the image VC format signal into a speech VC format signal and a control VC format signal.

In an embodiment, a return and format conversion step may be included; the converted speech VC format signal and control VC format signal will be returned to the corresponding VC circuit in the AI accessory device through path 3. Then, they will be transmitted to the corresponding speech SC circuit and control SC circuit through path 4, respectively, and converted into a speech SC format signal and a control SC format signal. In an embodiment, path 4 is a physical hard-wired connection between hardware circuits, but not limited thereto.

In an embodiment, an AI navigation step may be included. The converted speech SC format signal and control SC format signal will be used as the second multimodal data signal and transmitted to a map application program 302 (such as Google map) on the mobile device through path 5. Through the converted speech SC format signal, supplemented by the positioning system of the mobile device (such as Global Positioning System; GPS), the map application program 302 can provide voice navigation to inform the visually impaired person how to reach the destination.

In an embodiment, an AI navigation warning step may be included. In addition, the present disclosure also provides a road condition warning function to remind visually impaired persons through control signals.

In an embodiment, when the street view image signal is encapsulated into an image VC format and transmitted to the APP AIGC through path 2, the AIGC can determine whether the road condition is dangerous. In an embodiment, once the road condition is determined to be dangerous, the converted control VC format signal will be returned to the corresponding VC circuit in the AI accessory device through path 3, and then transmitted to the corresponding control SC circuit through path 4, converted into a control SC format signal, and then transmitted to the output terminal.

In an embodiment, an output and application step may be included. The output interface 114 is not limited to transmitting sound signals to speakers/headphones, but can also transmit control signals to control other devices, such as sensors or vibration motors.

In an embodiment, for example, a visually impaired person can use a guide cane, which has a built-in or wired/wireless connection to the AI accessory device 120. The guide cane can receive street view images captured by the camera, and the AI accessory device 120 converts them into at least one control signal and speech. The control signal will control the vibration motor in the guide cane, and the vibration motor will send vibration signals to the visually impaired person to warn them of dangerous road conditions ahead and require attention. This is the application of AI navigation and warning. In addition to warning about road conditions, the converted speech can also be used for navigation, informing the visually impaired person how to get to the destination (paths 1, 2, 3, 4, 9, 10, output interface 114).

In another embodiment, it is explained how to combine image/picture and speech input to achieve more advanced AI navigation functions.

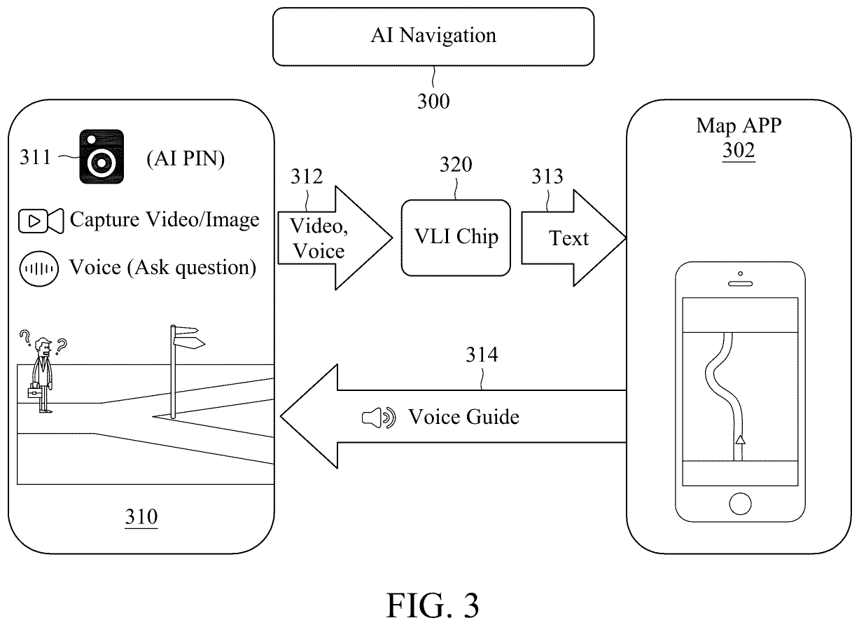

FIG. 3 is a schematic diagram of another possible embodiment of the AI accessory device of the present disclosure. As shown in FIG. 3, the input is changed to capturing video/images and speech (questions). Through path 1, the inputs are respectively transmitted to the image VC circuit 111 and the speech VC circuit 111, the street view image signal is encapsulated into an image VC format, and the speech input is encapsulated into a speech VC format, and then transmitted to the AI module 101 on the mobile device through path 2.

As shown in FIG. 2, the AI module 101 will convert the image VC format signal and the speech VC format signal into a text VC format signal, that is, navigation information.

In an embodiment, the converted text VC format signal will be returned to the corresponding text VC circuit 111 in the AI accessory device 120 through path 3, and then transmitted to the corresponding text SC circuit 112 via path 4, and converted into a text SC format signal. Path 4 is a physical hard-wired connection between hardware circuits.

The converted text SC format signal will be used as the second multimodal data signal and transmitted to the map application program 302 on the mobile device through path 5. Through the converted text SC format signal, supplemented by the GPS positioning of the mobile device, the map application program 302 can navigate the first user 130 (including visually impaired persons), and when set to voice mode, inform how to get to the destination through voice. Through the converted text SC format signal, the first user 130 (including visually impaired persons) can navigate to the destination in real time. This is the application of AI navigation.

All of the above applications are in multimodal mode. Through the integration of multiple sensory messages, it provides a safer and more convenient navigation experience for visually impaired persons.

The following uses a third embodiment to illustrate how to use the present disclosure to implement the AI clerical assistant function to assist users in processing paperwork.

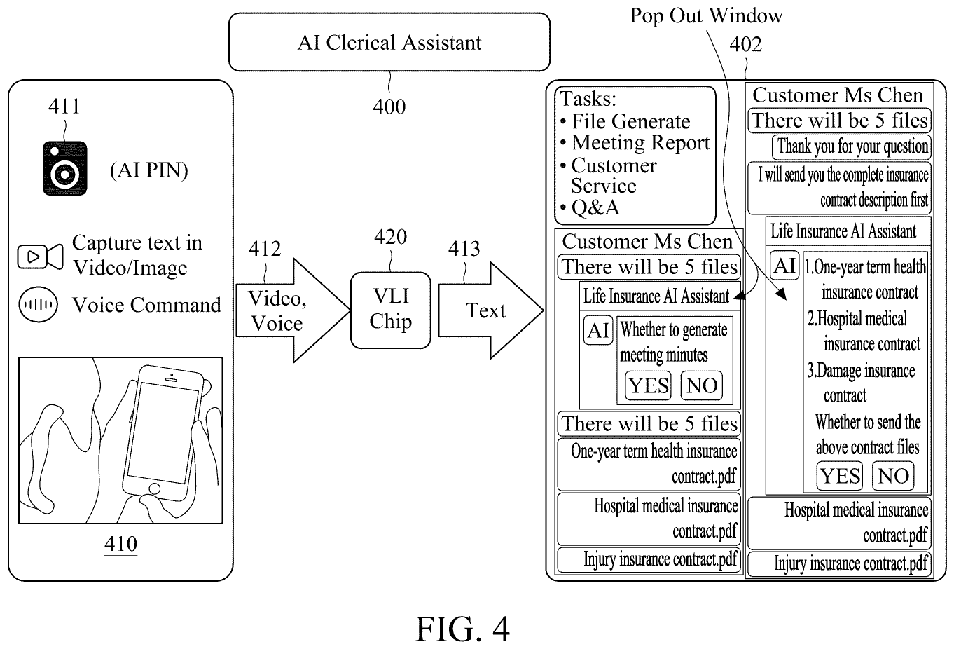

FIG. 4 is a schematic diagram of another possible embodiment of the AI accessory device of the present disclosure. As shown in FIG. 1 and FIG. 4, suppose an insurance salesperson uses a communication application program 402 (such as LINE APP) to discuss insurance content with a client. Afterwards, the insurance salesperson can use an image capture device (for example, included in the AI accessory device 411) to capture the text content on the communication application program 402 (such as LINE APP) into a video/image signal, and use voice commands as input. Finally, AI can assist in organizing the lengthy discussion content and generate electronic files, meeting minutes, customer service records, Q&A records, etc. The application scope is not limited thereto. The detailed steps of the third embodiment are as follows.

In an embodiment, it may include multimodal data capture and format conversion steps. The text video/image signal and voice command signal will be transmitted to the video/image VC circuit and the speech VC circuit through the input device (such as a camera, microphone) coupled to the input interface 113 and path 1, respectively. The video/image VC circuit encapsulates the text video/image signal into a text video/image VC format, and the speech VC circuit encapsulates the voice command signal into a speech VC format. Then, these data are transmitted to the APP AIGC on the mobile device through path 2.

In an embodiment, AI processing and information generation steps may be included. As shown in FIG. 2, the AIGC will convert the text video/image VC format signal and the speech VC format signal into a text VC format signal, that is, AI-processed information, including but not limited to electronic files, meeting minutes, customer service records, Q&A records, etc.

In an embodiment, return and format conversion steps may be included. The converted text VC format signal will be returned to the corresponding VC circuit 111 in the AI accessory device 120 through path 3, and then transmitted to the corresponding text SC circuit via path 4, and converted into a text SC format signal. Path 4 is a physical hard-wired connection between hardware circuits.

In an embodiment, it may include standard format data return and application steps. The converted text SC format signal will be used as the second multimodal data signal and transmitted to the LINE APP on the mobile device through path 5. When the salesperson uses the LINE APP on the mobile device, he can freely access the converted text SC format signal, including but not limited to information such as electronic files, meeting minutes, customer service records, Q&A records, etc.

In an embodiment, as shown in FIG. 4, it may include an AI clerical assistant interface. In an embodiment, when the LINE APP is opened on the mobile device, an AI clerical assistant window (for example, a pop-up window) will automatically pop up in the conversation screen between the salesperson and the client, asking related questions. The salesperson can click on the window and make selections according to the situation, providing information including but not limited to electronic files, meeting minutes, customer service records, Q&A records, etc.

Through the above steps, the embodiment of the present disclosure demonstrates how to use AI technology to implement the clerical assistant function, assist users in organizing information, generating documents, and improving work efficiency.

The AI clerical assistant function of the present disclosure can effectively assist salespersons in handling tedious paperwork, for example: automatically generating meeting minutes, saving organization time; quickly extracting important information, facilitating future reference; automatically generating customer service records, improving service quality; establishing a Q&A database, facilitating knowledge management.

The AI clerical assistant function of the embodiment of the present disclosure can be widely applied to various scenarios that require processing text information, such as business negotiations, online teaching, meeting minutes, etc., and has high practical value.

The following uses a fourth embodiment to illustrate how to use the present disclosure to implement AI live broadcast functions, such as real-time translation and display of product information.

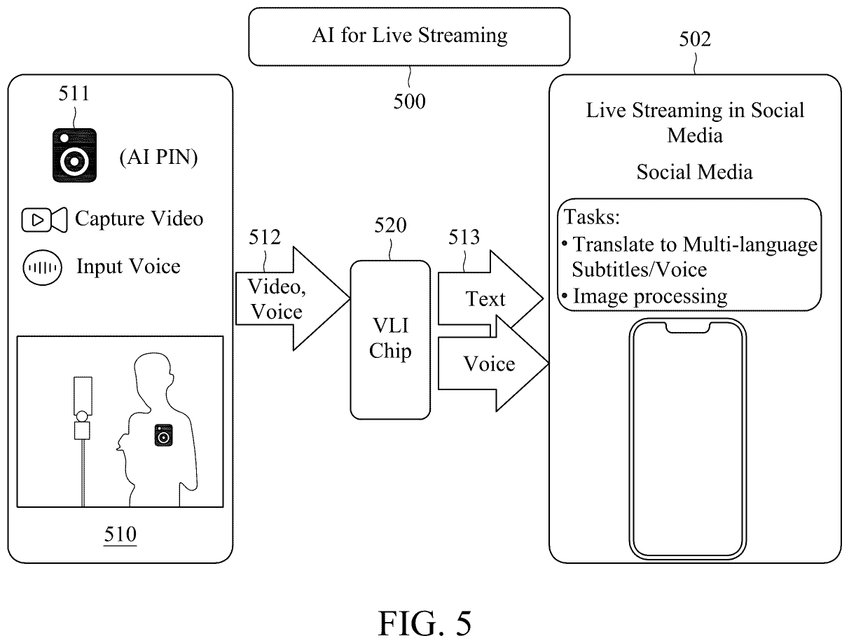

FIG. 5 is a schematic diagram of another possible embodiment of the AI accessory device of the present disclosure. As shown in FIG. 1 and FIG. 5, suppose a user (such as an internet celebrity) uses a live broadcast application program 502 (such as using FB, YouTube, Tik Tok, or other live broadcast APPs) to conduct live broadcasts to interact with fans/introduce products. The user can capture product images into image signals through the electronic device 110 (mobile device) or the image capture device of the AI accessory device 120, and use voice for introduction. Fans can see the translated voice and/or subtitles in real time through the live broadcast video, as well as product marketing information, such as product introductions, product specifications, or link URLs. The specific detailed steps are as follows.

In an embodiment, multimodal data capture and format conversion steps may be included. The product image signal and the user's voice signal will be transmitted to the image VC circuit and the speech VC circuit through the input device (such as a camera and microphone) coupled to the input interface 113 and path 1, respectively. The image VC circuit encapsulates the image signal into an image VC format, and the speech VC circuit encapsulates the voice signal into a speech VC format. Then, these data are transmitted to the AI module 101 (APP AIGC) on the mobile device through path 2.

In an embodiment, AI processing and information generation steps may be included. As shown in FIG. 5, the AIGC will convert the product video/image VC format signal and the speech VC format signal into a text VC format signal and a speech VC format signal, that is, AI-processed information, including but not limited to real-time translation of speech and/or subtitles, product marketing information (such as product introductions, product specifications, or link URLs), etc.

In an embodiment, a return and format conversion (text) step may be included. The converted text VC format signal will be returned to the corresponding VC circuit in the AI accessory device through path 3, and then transmitted to the corresponding text SC circuit via path 4, and converted into a text SC format signal. Path 4 is a physical hard-wired connection between hardware circuits.

In an embodiment, a standard format data return and application (text) step may be included. The converted text SC format signal will be used as the second multimodal data signal and transmitted to the FB APP live broadcast on the mobile device through path 5. Fans from various countries can see the translated subtitles in real time on the FB APP live broadcast on their respective mobile devices.

In an embodiment, a return and format conversion (speech) step may be included. The converted speech VC format signal will be returned to the corresponding VC circuit in the AI accessory device 120 through path 3, and then transmitted to the corresponding speech SC circuit via path 4, and converted into a speech SC format signal. Path 4 is a physical hard-wired connection between hardware circuits.

In an embodiment, a standard format data return and application (speech) step may be included. The converted speech SC format signal will be used as the second multimodal data signal and transmitted to the FB APP live broadcast on the mobile device through path 5. Fans from various countries can hear the translated speech in real time on the FB APP live broadcast on their respective mobile devices.

Through the above steps, the embodiment of the present disclosure demonstrates how to apply AI technology in live broadcasts, and the following effects can be obtained: overcoming language barriers, the real-time translation function allows fans from different countries to watch live broadcasts without barriers, expanding the audience; improving the viewing experience, providing multi-language subtitles, making it easier for fans to understand the live broadcast content; enhancing interaction, fans can interact with messages in their own language, improving participation; promoting product sales, displaying product information in real time, facilitating fans to understand and purchase products.

The AI live broadcast application of the embodiment of the present disclosure can improve the efficiency and effectiveness of live broadcasts, bringing more business opportunities to users and e-commerce platforms.

Referring to the aforementioned description, embodiments of the present disclosure include the following steps:

Data acquisition and format conversion step, in which the AI accessory device 120 receives the multimodal data through the input interface 113 from path 1, and packages it into a VC format by the VC circuit.

Data transmission and AI processing step, in which the VC format data is transmitted to the electronic device 110 (mobile device) through path 2, and the AI module 101 on the mobile device performs transformer processing. In an embodiment, the AI module 101 may be a software APP installed on the mobile device, or a built-in or cloud-based generative AI, such as Generative Adversarial Networks (GAN), Long Short-Term Memory (LSTM) or Transformer models (such as ChatGPT), capable of providing AI Generated Content (AIGC), but not limited thereto.

Multimodal conversion step, in which the transformer process can convert the received multimodal data into various combinations of images/video/text/speech/music/games/3D, called multimodality. For example, converting speech into text and speech, converting images into text and video, etc.

Return and format conversion step, in which the multimodal converted data (still in VC format) is returned to the AI accessory device 120 through path 3, and then sent to the SC circuit 112 via internal path 4 to convert the VC format to SC format.

Standard class format data return step, in which the AI accessory device 120 transmits the SC format data to the electronic device 110 through path 9 for execution and processing by the application program 102. The application program 102 treats the data in the standard class (SC) format as normal input, receives it and processes it. In an embodiment, the application program 102 may be a native/built-in APP of the mobile device, or an APP developed by a third party, as long as it is an application program that can accept SC format data.

Through the above, the present disclosure can achieve the following advantages:

Reducing the cost of AI accessory devices: the present disclosure utilizes the electronic device 110 (mobile device) or the cloud for AI processing, replacing the expensive DSP in traditional AI accessory devices, effectively reducing hardware costs.

Improving the AI capabilities of the application program 102: the present disclosure converts the AI processing results into SC format, so that the application program 102 of the electronic device 110 can receive and process the AI-processed data without upgrading, improving the functions and user experience of the application program 102.

Implementing multimodal conversion: the present disclosure supports the input and multimodal conversion of a variety of multimodal data, and can be flexibly applied to various AI scenarios, such as voice assistants, intelligent translation, multimedia content creation, etc.

The present disclosure provides an innovative AI accessory device, processing method and system. Through the cooperative operation of the AI accessory device 120 and the electronic device 110, it achieves efficient, flexible, and low-cost AI applications, and has broad market prospects.

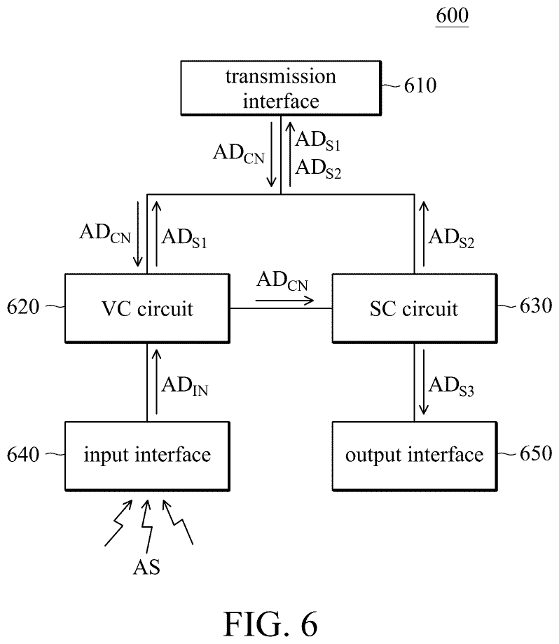

The following uses specific embodiments to illustrate the structure of the AI accessory device of the present disclosure. FIG. 6 is a schematic block diagram of the AI accessory device 120 of the present disclosure. As shown in the figure, the AI accessory device 600 includes: a transmission interface 610, a vendor-defined category (VC) circuit 620, a standard category (SC) circuit 630, an input interface 640, and an output interface 650.

The input interface 640 receives multimodal input AS to generate multimodal data AD_{IN}. The present disclosure does not limit the structure of the input interface 640. The input interface 640 can be used to input data such as images/video/text/speech/music/games/3D, and therefore can be equipped with image capture devices, such as video cameras, cameras, etc. The input interface 640 may also include sound capture devices, such as microphones, etc. Specifically, any input interface corresponding to at least one of the input multimodal data (images/video/text/speech/music/games/3D . . . ) can be used. In this way, the input multimodal data can be packaged into a vendor-defined class format by the vendor-defined category circuit 111.

In an embodiment, suppose the multimodal input AS is a speech spoken by the first user 130, and the multimodal data AD_{IN} is audio data corresponding to the speech.

The vendor-defined category circuit 620 generates a multimodal data signal AD_{S1} according to the input multimodal data AD_{IN}. In a possible embodiment, the vendor-defined category circuit 620 packages the multimodal data signal AD_{S1} into a signal in a vendor-defined class format.

In a possible embodiment, the multimodal data signal AD_{S1} is packaged into a signal in a vendor-defined format that includes text and sound.

In another possible embodiment, the vendor-defined category circuit 620 converts the input multimodal data AD_{IN} into a USB format, and then provides the converted result (i.e., the multimodal data signal AD_{S1}) to the electronic device 110 (e.g., a mobile device) through the transmission interface 610.

In a possible embodiment, the AI module 101 in the electronic device 110 processes and calculates the received multimodal data signal AD_{S1} to generate processed multimodal data AD_{CN} in a vendor-defined class format, and returns it to the vendor-defined category circuit 620 through the transmission interface 610.

In a possible embodiment, the processing and calculation performed by the AI module 101 in the electronic device 110 on the received multimodal data signal AD_{S1} is a real-time speech translation function, which converts the text included in the multimodal data signal AD_{S1} from Chinese to English, and converts the original Chinese sound into English sound, and combines the converted English text and English sound into processed multimodal data AD_{CN}.

In an embodiment, the AI module 101 of the electronic device 110 performs the above-mentioned real-time speech translation function, receives the multimodal data signal AD_{S1}, outputs the converted processed multimodal data AD_{CN}, and returns it to the vendor-defined category circuit 620 through the transmission interface 610. In a possible embodiment, the vendor-defined category circuit 620 stores the processed multimodal data AD_{CN}. At this time, the processed multimodal data AD_{CN} is a speech signal containing English text and has a sound similar to that of the first user 130.

In an embodiment, the standard category circuit 630 receives the processed multimodal data AD_{CN} through the vendor-defined category circuit 620, and converts the processed multimodal data AD_{CN} into a multimodal data signal AD_{S2} in a standard category format and provides it to the application program 102 of the electronic device 110. Since the multimodal data signal AD_{S2} is an English speech signal and has a sound similar to that of the first user 130, when the application program 102 provides the multimodal data signal AD_{S2} of English speech to the second user 140 who is talking to the first user 130 using the application program 102, the second user 140 can hear the English speech with a sound similar to that of the first user 130, thereby realizing real-time speech translation from Chinese speech to English speech.

In another embodiment, the standard category circuit 630 may convert the processed multimodal data AD_{CN} into a multimodal data signal AD_{S3} in a standard category format and provide it to the output interface 650. For example, if the output interface 650 is coupled to a speaker, the multimodal data signal AD_{S3} of English speech can be presented as English speech with a sound similar to that of the first user 130 through the speaker, thereby realizing real-time speech translation from Chinese speech to English speech.

In an embodiment, the application program 102 may present corresponding text according to the multimodal data signal AD_{S2} of speech. In this example, since the speech multimodal data signal AD_{S2} contains English text components, the application program 102 may present English text translated from the Chinese spoken by the first user, thereby realizing real-time translation from Chinese speech to English text.

The present disclosure does not limit the architecture of the standard category circuit 630. In a possible embodiment, the standard category circuit 630 is a USB audio class (UAC) circuit.

The transmission interface 610 is used to output the multimodal data signals AD_{S1} and AD_{S2}, and receive the processed multimodal data AD_{CN}. The present disclosure does not limit the type of the transmission interface 610. In this embodiment, the type of the transmission interface 610 only needs to be compatible with the electronic device 110. For example, the transmission interface 610 may be a wireless transceiver compatible with the electronic device 110. In other embodiments, the transmission interface 610 may be a USB connector compatible with the electronic device 110.

Since the vendor-defined category circuit 620 and the standard category circuit 630 are built in the AI accessory device 120 at the same time, when the AI accessory device 120 is connected to an electronic device 110, it can provide advanced AI functions to the application program 102 of the electronic device 110 without upgrading or updating the electronic device 110 and its application program 102.

For example, on the premise that the application program 102 of the original electronic device 110 only provides basic voice call and voice recognition functions, by connecting the AI accessory device 120 to the electronic device 110, it is possible to provide the AI-based real-time text and voice translation functions to the application program 102 of the electronic device 110 without upgrading or updating the electronic device 110 and its application program 102.

The following uses specific embodiments to illustrate the architecture of the AI accessory device and electronic device (mobile device) combined and used in the present disclosure.

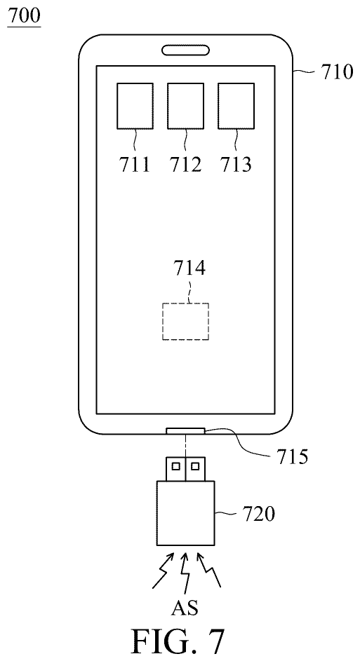

FIG. 7 is a schematic diagram of a system including an AI accessory device and an electronic device according to an embodiment of the present disclosure. As shown in the figure, the operating system 700 includes an electronic device 710 and an artificial intelligence (AI) accessory device 720.

The electronic device 710 includes application programs 711, 712, 713, an AI module 714, and a transmission interface 715. In other embodiments, the electronic device 110 has other hardware components, such as a central processing unit (CPU), a microprocessor, a microcontroller, a memory, etc.

The present disclosure does not limit the type of the electronic device 110. Any electronic device with a central processing unit (CPU) can be used as the electronic device 110. In this embodiment, the electronic device 110 is a smart mobile device. In this example, the electronic device 110 may operate on an Android system or an iOS system, but is not limited thereto. For example, the electronic device 110 may also be an electronic device operating on a Windows system or a Linux system.

For convenience of explanation, FIG. 7 only shows the features related to the present disclosure.

The electronic device 710 is coupled to the AI accessory device 720 and is configured to operate based on a first multimodal data signal received from the transmission interface 715.

In this embodiment, the transmission interface 715 is a USB interface that provides data transmission between the AI accessory device 720 and the electronic device 710, but is not limited thereto. For example, it may also be a wireless transmission interface that provides data transmission (such as Bluetooth, RF signal transmission, etc.).

In an embodiment, the application program 711 includes, but is not limited to, communication APPs such as Facebook Messenger, LINE, WhatsApp, Telegram, Signal, Wechat, etc. As mentioned above, the application program 711 transmits the received SC format data (such as text or voice communication content) to the AI accessory device 720 via the transmission interface 715, and then converts it into VC format data by the VC circuit 111 in the AI accessory device 720, and transmits it to the AI module 714 in the electronic device 710 via the transmission interface 715. The data processed by the AI module 714 (such as translated communication content) is transmitted to the AI accessory device 720 via the transmission interface 715, and then transmitted to the SC circuit 112 by the VC circuit 111 in the AI accessory device 720 to be converted into SC format data, and then transmitted to the application program 711 in the electronic device 710 via the transmission interface 715.

In this way, since the application program 711 receives data in SC format, the AI function provided by the AI module 714 can be implemented without upgrading or updating the application program 711.

In an embodiment, the application program 712 includes, but is not limited to, map application programs such as Google Maps, and the application program 713 includes, but is not limited to, live broadcast application programs such as TikTok, LINE Live, Facebook, Instagram, X (formerly known as Twitter), etc. Through a process similar to that of the application program 711, the AI function provided by the AI module 714 can be implemented without upgrading or updating the application programs 712 and 713.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An artificial intelligence (AI) accessory device for coupling to an electronic device, the AI accessory device comprising:
an input interface configured to receive a multimodal input and to transmit multimodal data corresponding to the multimodal input;
a vendor-defined category circuit coupled to the input interface and configured to receive the multimodal data from the input interface and to provide a first multimodal data signal in a vendor-defined category format to the electronic device, wherein the first multimodal data signal is configured to be processed by an AI module of the electronic device to generate processed multimodal data for the vendor-defined category circuit;
a standard category circuit configured to receive the processed multimodal data from the vendor-defined category circuit and to provide the processed multimodal data as a second multimodal data signal in a standard category format to an application of the electronic device; and
a transmission interface couple to the electronic device and configured to transmit and receive the first multimodal data signal, the second multimodal data signal, and the processed multimodal data.

2. The AI accessory device as claimed in claim 1, wherein the first multimodal data signal is in a vendor-defined category format, and the second multimodal data signal is in a standard category format.

3. The AI accessory device as claimed in claim 1, wherein the application is a communication application configured to transmit and receive at least one of text messages and voice messages; and
wherein the AI module is configured to process the first multimodal data signal by converting the first multimodal data signal comprising a first language into the processed multimodal data comprising a second language.

4. The AI accessory device as claimed in claim 1, wherein the application is a map application configured to receive text and output voice navigation; and
wherein the AI module is configured to process the first multimodal data signal by converting the first multimodal data signal comprising at least one of an image, a video, and speech into the processed multimodal data comprising text.

5. The AI accessory device as claimed in claim 1, wherein the application is a communication application configured to transmit and receive at least one of text, video, and images; and
wherein the AI module is configured to process the first multimodal data signal by converting the first multimodal data signal comprising at least one of text, video, images, and speech into the processed multimodal data comprising at least one of an electronic file, meeting minutes, customer service records, and a question-and-answer record, the at least one of an electronic file, meeting minutes, customer service records, and a question-and-answer record comprising text.

6. The AI accessory device as claimed in claim 1, wherein the application is a live broadcast application configured to transmit and receive at least one of speech, video, and images; and
wherein the AI module is configured to process the first multimodal data signal by converting the first multimodal data signal comprising the at least one of speech, video, and images into the processed multimodal data comprising text, speech, and processed images.

7. The AI accessory device as claimed in claim 1, wherein the AI module is a generative AI installed in the electronic device or located in a cloud, and wherein the generative AI is one of a generative adversarial network, a long short-term memory network, or a Transformer model; and
wherein the multimodal input comprises at least one of text, speech, music, images, video, games, and 3D models.

8. An operating system, comprising an electronic device and the AI accessory device as claimed in claim 1;
wherein the electronic device comprises:
an AI module, wherein the AI module is a generative AI installed in the electronic device or located in a cloud, and wherein the generative AI is one of a generative adversarial network, a long short-term memory network, or a Transformer model; and
an application installed in the electronic device and configured to receive the second multimodal data signal.

9. A control method for an artificial intelligence (AI) operating system, the operating system comprising an electronic device and the AI accessory device as claimed in claim 1;
wherein the electronic device comprises:
an AI module, wherein the AI module is a generative AI installed in the electronic device or located in a cloud, and wherein the generative AI is one of a generative adversarial network, a long short-term memory network, or a Transformer model; and
an application installed in the electronic device and configured to receive a multimodal data signal;
the control method comprising:
a data acquisition and format conversion step, wherein the AI accessory device receives the multimodal data through the input interface and transmits the multimodal data to the vendor-defined category circuit, and the vendor-defined category circuit packages the multimodal data into the first multimodal data signal in the vendor-defined category format;
a data transmission and AI processing step, transmitting the first multimodal data signal to the electronic device, wherein the AI module of the electronic device performs a conversion process;
a multimodal conversion step, wherein the conversion process converts the first multimodal data signal received by the electronic device into the processed multimodal data;
a return and format conversion step, transmitting the processed multimodal data, which is still in the vendor-defined category format, to the AI accessory device, and transmitting the processed multimodal data to the standard category circuit, which converts the processed multimodal data from the vendor-defined category format into the second multimodal data signal in the standard category format; and
a standard format data return step, wherein the AI accessory device transmits the second multimodal data signal in the standard category format to the electronic device for execution and processing by the application.
